(19) United States
(12) Patent Application Publication
(10) Pub. No.: US 2007/0294396 A1
(43) Pub. Date: Dec. 20, 2007

(54) Method and system for researching pestware spread through electronic messages

(76) Inventor: Eryk W. Krzaczynski, Denver, CO (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/453,735

(22) Filed: Jun. 15, 2006

(51) Int. Cl. G06F 15/173

(52) U.S. Cl. 709/224

(57) ABSTRACT

A method and system for researching pestware spread through electronic messages is described. One embodiment detects automatically the presence of an electronic messaging client on a computer, the electronic messaging client having an associated contact list, each contact in the contact list having an associated address on a network; adds automatically a pestware research contact to the contact list, the address associated with the pestware research contact pointing to a data collection system on the network; and traces to its source on the network a pestware threat received at the data collection system via the pestware research contact. The principles of the invention can be applied to any electronic messaging system, including electronic mail and instant messaging.

### RELATED APPLICATIONS

The present application is related to the following commonly owned and assigned applications: U.S. application Ser. No. 10/956,274, Attorney Docket No. WEBR-004/00US, entitled “System and Method for Locating Malware”; U.S. application Ser. No. 10/956,818, Attorney Docket No. WEBR-006/00US, entitled “System and Method for Locating Malware and Generating Malware Definitions”; U.S. application Ser. No. 10/956,575, Attorney Docket No. WEBR-007/00US, entitled “System and Method for Actively Operating Malware to Generate a Definition”; U.S. application Ser. No. 11/079,417, Attorney Docket No. WEBR-012/00US, entitled “System and Method for Analyzing Data for Potential Malware”; U.S. application Ser. No. 11/171,924, Attorney Docket No. WEBR-017/00US, entitled “Systems and Methods for Identifying Malware Distribution Sites”; U.S. application Ser. No. 11/199,468, Attorney Docket No. WEBR-021/00US, entitled “Systems and Methods for Collecting Files Related to Malware”; and U.S. application Ser. No. 11/180,161, Attorney Docket No. WEBR-022/00US, entitled “Systems and Methods for Identifying Sources of Malware”; each of which is incorporated herein by reference.

### FIELD OF THE INVENTION

The present invention relates generally to protecting computers from malware or pestware. In particular, but not by way of limitation, the present invention relates to techniques for researching malware or pestware distributed through electronic messaging systems such as electronic mail (e-mail) and instant messaging (IM).

### BACKGROUND OF THE INVENTION

Protecting personal computers against a never-ending onslaught of “pestware” such as viruses, Trojan horses, spyware, adware, and downloaders on personal computers has become vitally important to computer users. Some pestware is merely annoying to the user or degrades system performance. Other pestware is highly malicious. Many computer users depend on anti-pestware software that attempts to detect and remove pestware automatically. Anti-pestware software typically scans running processes in memory and files contained on storage devices such as disk drives, comparing them, at expected locations, against a set of “signatures” that identify specific, known types of pestware. To be effective, the signatures have to be updated frequently to keep the anti-pestware software abreast of the latest pestware threats.

The Internet provides a channel through which pestware can be distributed to a large number of computers, resulting in inconvenience, lost productivity, and sometimes damage to valuable data. In some cases, pestware is spread through electronic messaging systems such as electronic mail (e-mail) and instant messaging (IM), the latter being a popular real-time, electronic, text-based communication medium. Pestware that has successfully infested one machine can spread itself to an exponentially increasing number of other computers by automatically sending e-mail messages or instant messages to all of the people in the user's e-mail address book or IM “buddy list.”

The distribution of pestware via electronic messages is particularly troublesome because the recipients are often led to believe the message has been received from a trusted source. The received electronic message may contain text such as “I know you're going to want to see this picture!” Such text is often accompanied by a hyperlink to a Uniform Resource Locator (URL) (e.g., the Internet address of a Web site) associated with a pestware payload located elsewhere on the Internet. Clicking on the hyperlink causes the pestware payload to be downloaded to the requesting computer and installed, and the new victim's e-mail or IM client becomes the means of spreading the pestware to still more users, and so on. The URL embedded in the electronic message may also be obfuscated. That is, the hyperlink itself may appear harmless, but the actual URL to which the hyperlink points is associated with pestware.

Since the spread of pestware via electronic messages tends to increase exponentially, prompt and early development of detection signatures or “definitions” and distribution of those signatures or definitions to anti-pestware software applications installed on protected systems is crucial. The early development of detection tools is hampered, however, by the often rapid disappearance of the original pestware payload from its source on the Internet. For example, the authorities may shut down the offending Web site shortly after the pestware attack has begun. Consequently, conventional pestware threat research techniques do not deal effectively with pestware that is spread via electronic messages.

It is thus apparent that there is a need in the art for an improved method and system for researching pestware spread through electronic messages.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for researching pestware spread through electronic messages. One illustrative embodiment is a method for researching pestware, comprising detecting automatically the presence of an electronic messaging client on a computer, the electronic messaging client having an associated contact list, each contact in the contact list having an associated address on a network; adding automatically a pestware research contact to the contact list, the address associated with the pestware research contact pointing to a data collection system on the network; and tracing to its source on the network a pestware threat received at the data collection system via the pestware research contact.

Another illustrative embodiment is a system for researching pestware, comprising an electronic messaging client detection module configured to detect automatically the presence of an electronic messaging client on a computer, the electronic messaging client having an associated contact list, each contact in the contact list having an associated address on a network; a contact installation module configured to add automatically a pestware research contact to the contact list; and a data collection subsystem connected with the network, the address associated with the pestware research contact pointing to the data collection subsystem. In this embodiment, the data collection subsystem is configured to receive at the address associated with the pestware research contact an electronic message associated with a pestware threat and to trace the pestware threat to its source on the network using information derived from the received electronic message. These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a system for researching pestware in accordance with an illustrative embodiment of the invention;

FIG. 2 is a functional block diagram of a data collection system for gathering information used in detecting pestware in accordance with an illustrative embodiment of the invention;

FIG. 3 is an illustration of an instant messaging client in accordance with an illustrative embodiment of the invention;

FIG. 4 is an illustration of an instant message associated with a pestware threat in accordance with an illustrative embodiment of the invention;

FIG. 5 is a flowchart of a method for researching pestware in accordance with an illustrative embodiment of the invention; and

FIG. 6 is a flowchart of a method for researching pestware in accordance with another illustrative embodiment of the invention.

### DETAILED DESCRIPTION

“Pestware,” as used herein, refers to any program that damages or disrupts a computer system or that collects or reports information about a person or an organization. Examples include, without limitation, viruses, worms, Trojan horses, spyware, adware, and downloaders. “Researching” pestware is sometimes used herein to refer to the process of discovering new types of pestware and tracing them to their points of origin. An “electronic message,” as used herein, refers to any type of message containing at least text that is sent over a network from one computing device to one or more other computing devices. An electronic message may be based on a “store-and forward” architecture such as electronic mail (e-mail), an instant messaging (IM) architecture, or other electronic messaging architecture. Those skilled in the art will recognize that the network can be hardwired, wireless, or a combination thereof.

In an illustrative embodiment, a “decoy” is created that provides early warning of pestware spread via electronic messaging. The early warning facilitates retrieving the payload from its source before it is removed from the network, thereby allowing characteristics (e.g., signatures or definitions) of the payload to be derived that can be used to detect the payload on an affected computer.

In this illustrative embodiment, the presence of an electronic messaging client on a computer is detected automatically. This can be done, for example, by an anti-pestware software application installed on the computer or by some other program. If the computer has an electronic messaging client installed, a pestware research contact is automatically added to the user's contact list. In the context of e-mail, the contact list is often called an “address book.” Such an address book may be integrated with other personal information management (PIM) functions such as calendar and tasks in some e-mail client programs. One such popular e-mail client is sold by Microsoft Corporation under the trade name OUTLOOK.

In the context of IM, the contact list is sometimes called a “buddy list.” In general, the contact list is a set of known people with whom a computer user communicates through electronic messages. The network address associated with the added pestware research contact points to a data collection system on a network. For example, the data collection system may be operated by an entity that produces anti-pestware software. In one embodiment, the electronic messaging client is configured to conceal the pestware research contact from the user. For example, in that embodiment, the pestware research contact is not displayed on the contact list.

When the computer subsequently suffers a pestware attack that spreads via electronic messages, the pestware threat is typically sent to all contacts on the user's contact list, including the automatically added pestware research contact. This means the data collection system immediately receives an electronic message associated with the pestware threat. The electronic message associated with the pestware threat can then be traced to its source (e.g., a Web site) before the payload becomes unavailable. Once obtained, the payload can be analyzed and signatures or definitions developed for detecting the pestware on an affected computer. These signatures or definitions can then be promptly distributed to protected computers running compatible anti-pestware software.

In the illustrative embodiment just described, the network includes the Internet. In other embodiments, a different network or combination of networks may be involved.

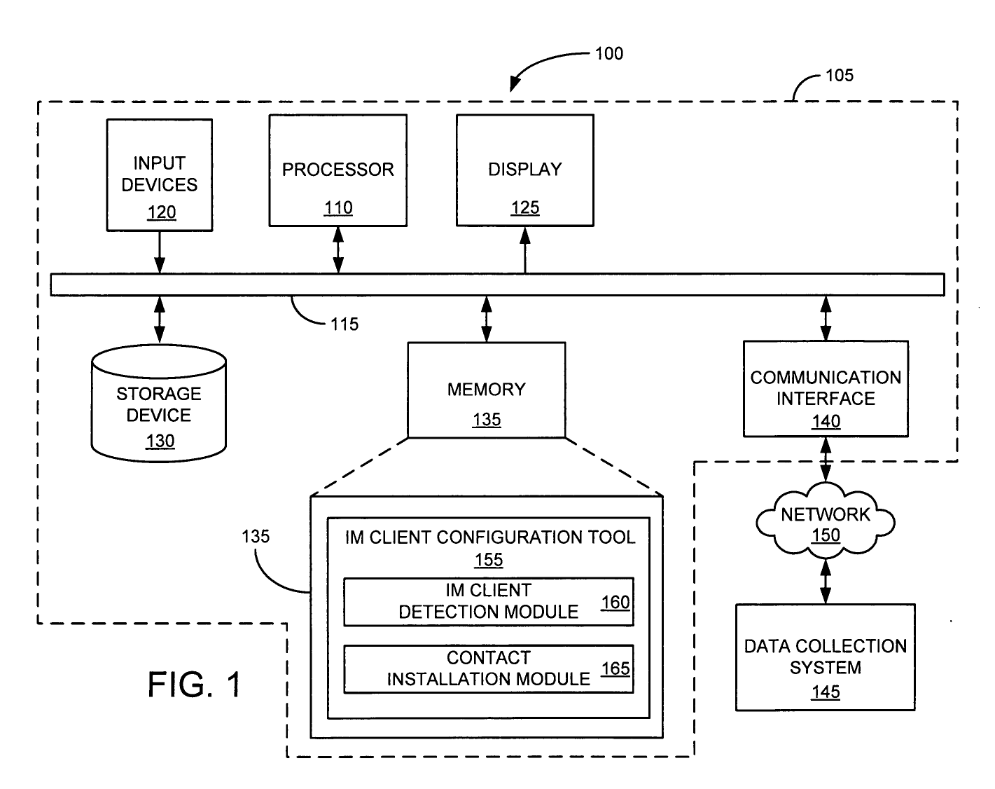

Referring now to the drawings, where like or similar elements are designated with identical reference numerals throughout the several views, and referring in particular to FIG. 1, it is a functional block diagram of a system for researching pestware (“system 100”) in accordance with an illustrative embodiment of the invention. System 100 is embodied in part on computer 105 (enclosed by dashed lines in FIG. 1). Computer 105 can be a desktop computer, workstation, laptop computer, notebook computer, handheld computer, or any other device that includes computing functionality. In FIG. 1, processor 110 communicates over data bus 115 with input devices 120, display 125, storage device 130, memory 135, and communication interface 140. Communication interface 140 allows computer 105 to communicate with other computers, including data collection system 145, over network 150.

Input devices 120 may be, for example, a keyboard and a mouse or other pointing device. In an illustrative embodiment, storage device 130 is a magnetic-disk device such as a hard disk drive (HDD). In other embodiments, however, storage device 130 can be any type of computer storage device, including, without limitation, a magnetic-disk drive, an optical-disc drive, and a storage device employing flash-memory-based media such as secure digital (SD) cards or multi-media cards (MMCs). Memory 135 may include random-access memory (RAM), read-only memory (ROM), or a combination thereof.

In FIG. 1, memory 135 contains IM client configuration tool 155. In the illustrative embodiment of FIG. 1, IM client configuration tool 155 is an application program stored on a computer-readable storage medium of computer 105 (e.g., on storage device 130) that can be loaded into memory 135 and executed by processor 110. In other embodiments, the functionality of IM client configuration tool 155 can be implemented in software, firmware, hardware, or any combination thereof.

For convenience in this Detailed Description, the functionality of IM client configuration tool 155 has been divided into two modules, IM client detection module 160 and contact installation module 165. In various embodiments of the invention, the functionality of IM client detection module 160 and contact installation module 165 may be combined or subdivided in ways other than that indicated in FIG. 1.

As mentioned above, IM client configuration tool 155 can be part of an anti-pestware software application or some other application. Alternatively, IM client configuration tool 155 can be a standalone application.

In the embodiment of FIG. 1, IM client detection module 160 automatically detects the presence of an installed IM client (not shown in FIG. 1) on computer 105. Those skilled in the art will recognize that this can be done in a variety of ways, including, without limitation, searching for an installation directory or directories with known characteristics and searching a registry of the operating system of computer 105. In operating systems such as those sold by Microsoft Corporation under the trade name WINDOWS, for example, a registry is used, in part, to keep track of which applications are installed on the system.

Once IM client detection module 160 has detected an IM client on computer 105, contact installation module 165 automatically and unobtrusively adds a contact or “buddy” to the user's IM contact list (or “buddy list”). The added contact is termed herein a “pestware research contact.” The pestware research contact has an associated IM address on network 150 that coincides with data collection system 145. In one embodiment, the IM client of computer 105 conceals the pestware research contact from the user. Those skilled in the art will recognize that an IM client can be designed to treat a contact having a predetermined attribute differently from other contacts by, e.g., not displaying that contact on display 125. This practice also helps prevent a pestware process from discovering the presence of the pestware research contact and avoiding the sending of an instant message to the pestware research contact.

In the illustrative embodiment of FIG. 1, system 100 is also embodied in part in data collection system 145. Data collection system 145 acts as a collection point for instant messages that are sent by pestware to all contacts on the contact list belonging to the user of computer 105. The user of computer 105 would normally not intentionally send an instant message to the (possibly hidden) pestware research contact. Therefore, any instant messages received at data collection system 145 are likely to be associated with pestware attacks. The pestware research contact thus acts as a “decoy” or “victim” through which the source of a pestware threat sent via IM can be traced.

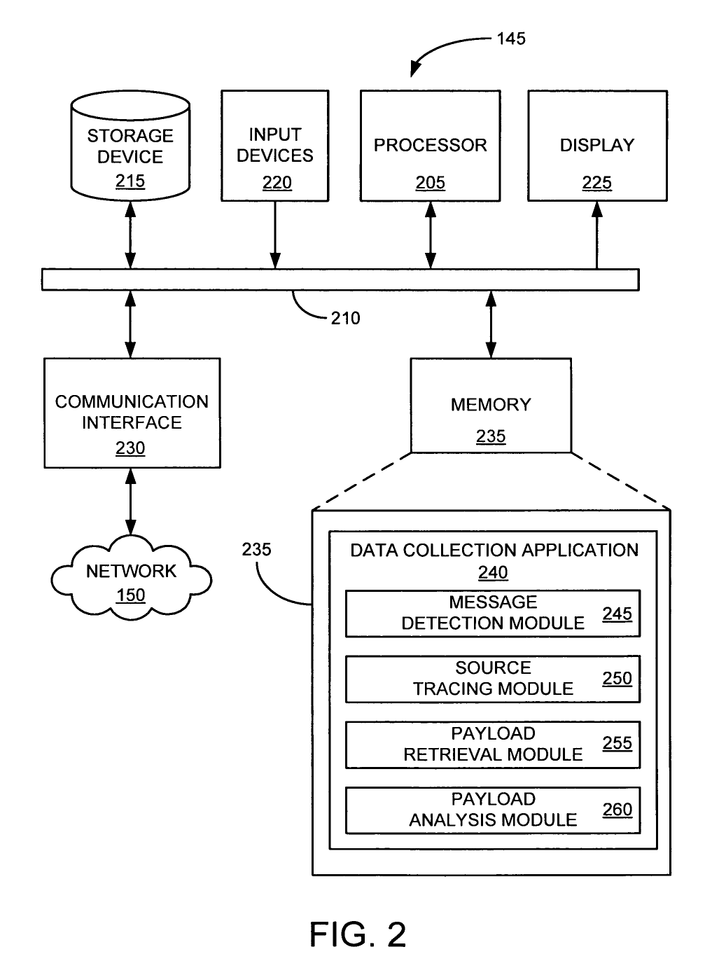

FIG. 2 is a functional block diagram of data collection system 145 in accordance with an illustrative embodiment of the invention. With respect to system 100 shown in FIG. 1, data collection system may also be termed a “subsystem.” In FIG. 2, processor 205 communications over data bus 210 with storage device 215, input devices 220, display 225, communication interface 230, and memory 235. Communication interface 230 allows data collection system 145 to communicate with other computers over network 150.

Input devices 220 may be, for example, a keyboard and a mouse or other pointing device. In an illustrative embodiment, storage device 215 is a magnetic-disk device such as a HDD or other suitable computer storage device. Memory 235 may include RAM, ROM, or a combination thereof.

In the illustrative embodiment of FIG. 2, memory 235 contains data collection application 240. Data collection application 240 is an application program stored on a computer-readable storage medium of data collection system 145 (e.g., on storage device 215) that can be loaded into memory 235 and executed by processor 205. In other embodiments, the functionality of data collection application 240 can be implemented in software, firmware, hardware, or any combination thereof.

For convenience in this Detailed Description, the functionality of data collection application 240 has been divided into four modules: message detection module 245, source tracing module 250, payload retrieval module 255, and payload analysis module 260. In various embodiments of the invention, the functionality of these modules may be combined or subdivided in ways other than that indicated in FIG. 2.

In the illustrative embodiment of FIG. 2, message detection module 245 detects the arrival of instant messages at data collection system 145. Any instant message received by message detection module 245 may be presumed, at least initially, to be associated with a pestware threat. Of course, misdirected or accidental messages are also possible. In one embodiment, message detection module 245 is simply an IM client application that is linked to other parts of data collection application 240 such as source tracing module 250. In other embodiments, a human user manually retrieves messages from message detection module 245 and performs the functions associated with source tracing module 250, payload retrieval module 255, and payload analysis module 260.

Source tracing module 250 traces a pestware threat associated with an instant message received by message detection module 245 to the source of the pestware threat on network 150. To do so, source tracing module 250 uses information derived from the received instant message. For example, the instant message may contain a hyperlink pointing to a Uniform Resource Locator (URL) on network 150 that is associated with the pestware. The hyperlink may even obfuscate (disguise or obscure) the URL. In some embodiments, the hyperlink may be followed to infect a pestware research computer deliberately under controlled conditions.

Payload retrieval module 255 retrieves a payload (e.g., executable file or compressed executable file) associated with the pestware threat from the identified source of the pestware threat. As already mentioned, payload retrieval module 255 may do so by causing a pestware research computer to become infected with the pestware under controlled conditions. Alternatively, the payload can simply be downloaded to a pestware research computer in a controlled environment where it can be analyzed.

Payload analysis module 260 is configured to derive from the payload at least one characteristic for use in detecting the payload on an affected computer. Such a characteristic can be termed a “signature” or “definition” for the applicable variety of pestware. In some embodiments, payload analysis module 260 is configured to extract such characteristics automatically based on a set of predetermined criteria. In other embodiments, payload analysis module 260 includes an interactive user interface that aids a human operator in analyzing the pestware payload. In still other embodiments, the functionality of payload analysis module 260 is performed manually by the human operator.

Data collection system 145 facilitates acquiring the pestware payload promptly, before the payload has been removed from network 150 (by the authorities or otherwise). This allows pestware detection definitions to be developed and distributed to anti-pestware software customers sooner than would otherwise be possible.

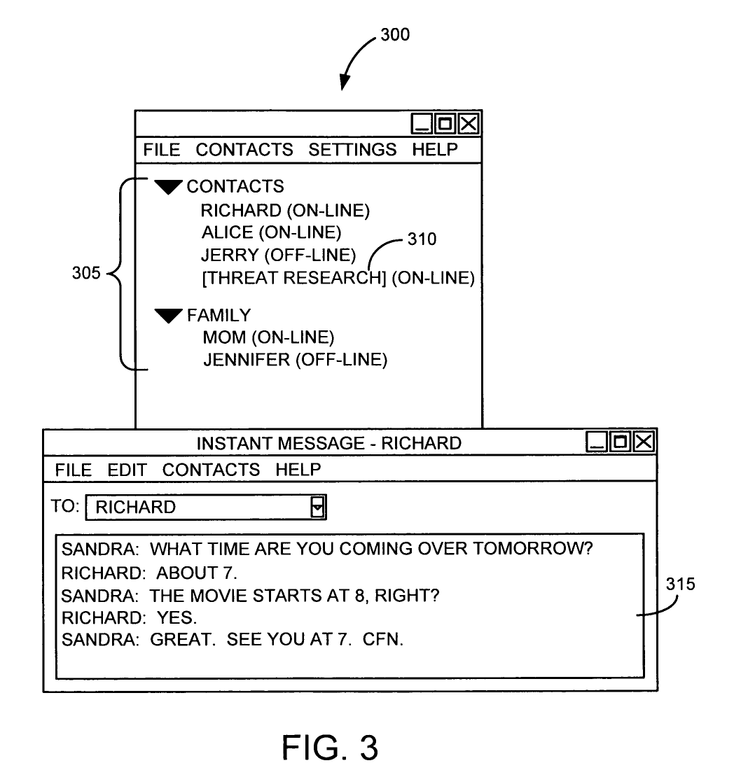

FIG. 3 is an illustration of an IM client 300 as it might appear on display 125 of computer 105, in accordance with an illustrative embodiment of the invention. IM client 300 can be any type of IM client such as AOL INSTANT MESSENGER (AIM), MSN MESSENGER, YAHOO MESSENGER, or ICQ (an acronym suggesting “I seek you”), or IM client 300 can be a messaging application such as TRILLIAN that provides a “front end” interface to multiple proprietary IM clients simultaneously. IM client 300 includes contact list 305. Each contact in contact list 305 has an associated unique IM address (an electronic address on network 150). As explained above, contact installation module 165 adds pestware research contact 310 to contact list 305. The IM address associated with pestware research contact 310 points to data collection system 145. Pestware research contact 310 is shown in square brackets in FIG. 3 to set it apart from the user's personal contacts. As explained above, IM client 300 may be configured, in some embodiments, to conceal the existence of pestware research contact 310 from the user of computer 105 or at least to refrain from displaying pestware research contact 310 in contact list 305. FIG. 3 also shows a representative instant message 315.

In FIG. 3, IM client 300 indicates whether each contact in contact list 305 is currently on-line or not. Those skilled in the art will recognize that it is preferable for pestware research contact 310 to be on-line at all times, if possible. Barring service outages, data collection system 145 is thus continually connected with network 150, and message detection module 245 is configured to receive instant messages at any time.

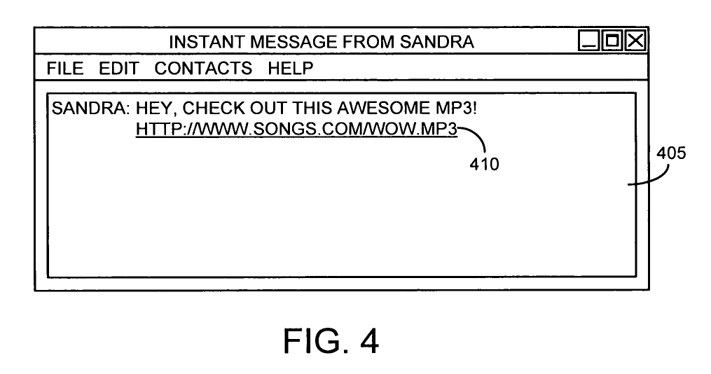

FIG. 4 is an illustration of an instant message 405 associated with a pestware threat in accordance with an illustrative embodiment of the invention. In the example shown in FIG. 4, instant message 405 includes text inviting the recipient to click on a hyperlink 410 that appears to point to an mp3 (music) file on the World Wide Web. As explained above, hyperlink 410 may in reality point to a destination on network 150 associated with pestware. If the user of computer 105 were to follow such a hyperlink, computer 105 could become corrupted by pestware that is downloaded to and automatically installed on computer 105. The pestware could then further propagate itself by sending a message like instant message 405 to everyone on the user's contact list 305, including pestware research contact 310, thereby alerting data collection system 145.

In an illustrative embodiment, source tracing module 250 locates the source of the pestware threat by following hyperlink 410 to its associated URL.

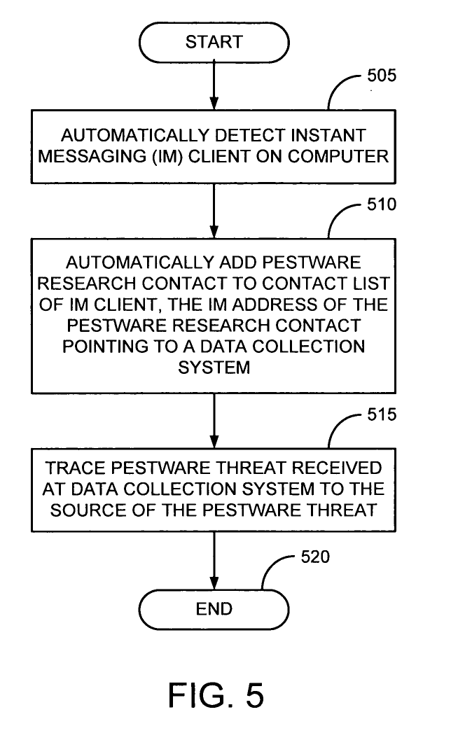

FIG. 5 is a flowchart of a method for researching pestware in accordance with an illustrative embodiment of the invention. At 505, IM client detection module 160 automatically detects the presence of IM client 300 on computer 105. At 510, contact installation module 165 automatically adds pestware research contact 310 to contact list 305. At 515, source tracing module 250 traces to its source on network 150 a pestware threat received via pestware research contact 310 at data collection system 145. The process terminates at 520.

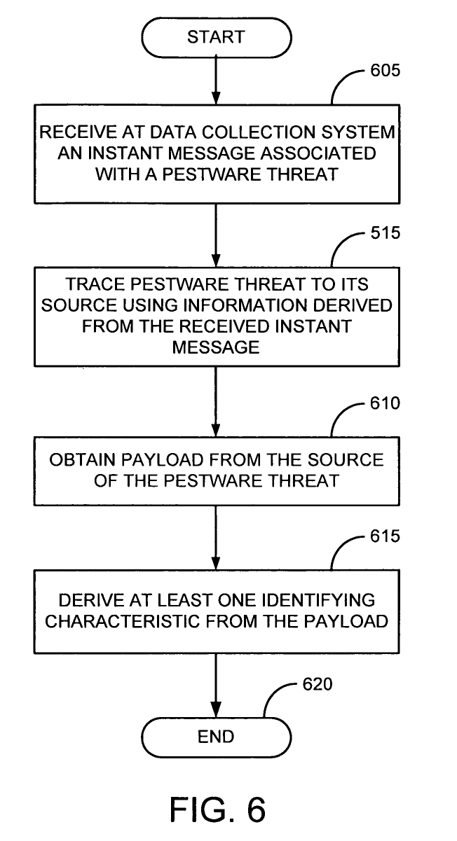

FIG. 6 is a flowchart of a method for researching pestware in accordance with another illustrative embodiment of the invention. At 605, an instant message 405 associated with a pestware threat is received at data collection system 145 and detected by message detection module 245. Block 515 is carried out as described in connection with FIG. 5. At 610, payload retrieval module 255 retrieves from the source identified at 515 a payload associated with the received pestware threat. At 615, payload analysis module 260 derives from the payload at least one identifying characteristic that can be used to detect the payload on an affected computer.

Though the foregoing embodiments discussed in connection with FIGS. 1-6 focus on IM, the principles of the invention are readily and analogously applied to e-mail. In an illustrative e-mail embodiment, IM client detection module 160 becomes an e-mail client detection module (in general, an electronic messaging client detection module) that automatically detects the presence of an e-mail client on computer 105. In this embodiment, contact installation module 165 automatically adds pestware research contact 310 to an address book associated with the e-mail client. The remaining aspects of this illustrative e-mail embodiment (e.g., those concerning data collection system 145) are directly analogous to the IM embodiments described above, the difference being that e-mail is the electronic messaging architecture instead of IM.

In conclusion, the present invention provides, among other things, a method and system for researching pestware spread through electronic messages. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, the principles of the invention can be applied to e-mail and IM clients other than those specifically mentioned. Also, the principles of the invention can be applied to a variety of operating systems other than WINDOWS operating systems, including UNIX and the operating system marketed under the trade name LINUX.

What is claimed is:

1. A method for researching pestware, the method comprising:
detecting automatically the presence of an electronic messaging client on a computer, the electronic messaging client having an associated contact list, each contact in the contact list having an associated address on a network;
adding automatically a pestware research contact to the contact list, the address associated with the pestware research contact pointing to a data collection system on the network; and
tracing to its source on the network a pestware threat received at the data collection system via the pestware research contact.

2. The method of claim 1, wherein the electronic messaging client is one of an electronic mail (e-mail) client and an instant messaging (IM) client.

3. The method of claim 1, further comprising:
obtaining from the source of the pestware threat a payload associated with the pestware threat; and
deriving from the payload at least one characteristic for use in detecting the payload on a computer.

4. The method of claim 1, wherein the electronic messaging client conceals the pestware research contact from a user of the computer.

5. The method of claim 1, wherein the tracing includes following a hyperlink to a Uniform Resource Locator (URL) on the network.

6. The method of claim 1, wherein the network includes the Internet.

7. A method for gathering information used in detecting pestware, the method comprising:
receiving over a network at a data collection system an electronic message associated with a pestware threat, the electronic message having been addressed to a pestware research contact, the pestware research contact having been added automatically to a contact list associated with an electronic messaging client on a remote computer connected with the network, the pestware research contact having an associated network address that points to the data collection system;
tracing the pestware threat to its source on the network using information derived from the received electronic message;
obtaining from the source of the pestware threat a payload associated with the pestware threat; and
deriving from the payload at least one characteristic for use in detecting the payload on an affected computer.

8. The method of claim 7, wherein the electronic messaging client is one of an electronic mail (e-mail) client and an instant messaging (IM) client and the electronic message is one of an e-mail message and an instant message.

9. The method of claim 7, wherein the tracing includes following a hyperlink to a Uniform Resource Locator (URL) on the network.

10. The method of claim 7, wherein the network includes the Internet.

11. A system for researching pestware, the system comprising:
an electronic messaging client detection module configured to detect automatically the presence of an electronic messaging client on a computer, the electronic messaging client having an associated contact list, each contact in the contact list having an associated address on a network;
a contact installation module configured to add automatically a pestware research contact to the contact list; and
a data collection subsystem connected with the network, the address associated with the pestware research contact pointing to the data collection subsystem, the data collection subsystem being configured to:
receive at the address associated with the pestware research contact an electronic message associated with a pestware threat; and
trace the pestware threat to its source on the network using information derived from the received electronic message.

12. The system of claim 11, wherein the electronic messaging client is one of an electronic mail (e-mail) client and an instant messaging (IM) client and the electronic message is one of an e-mail message and an instant message.

13. The system of claim 11, wherein the data collection subsystem is further configured to:
obtain from the source of the pestware threat a payload associated with the pestware threat; and
derive from the payload at least one characteristic for use in detecting the payload on an affected computer.

14. The system of claim 11, wherein the data collection subsystem is configured to trace the pestware threat to its source by following a hyperlink to a Uniform Resource Locator (URL) on the network.

15. The system of claim 11, wherein the network includes the Internet.

16. A data collection system for gathering information used in detecting pestware, the system comprising:
a communication interface connected with a network;
a message detection module configured to receive through the communication interface an electronic message associated with a pestware threat, the electronic message having been addressed to a pestware research contact, the pestware research contact having been added automatically to a contact list associated with an electronic messaging client on a remote computer connected with the network, the pestware research contact having an associated network address that points to the data collection system;
a source tracing module configured to trace the pestware threat to its source on the network using information derived from the received electronic message;
a payload retrieval module configured to retrieve from the source of the pestware threat a payload associated with the pestware threat; and
a payload analysis module configured to derive from the payload at least one characteristic for use in detecting the payload on an affected computer.

17. The data collection system of claim 16, wherein the electronic messaging client is one of an electronic mail (e-mail) client and an instant messaging (IM) client and the electronic message is one of an e-mail message and an instant message.

18. The data collection system of claim 16, wherein the source tracing module is configured to trace the pestware threat to its source on the network by following a hyperlink to a Uniform Resource Locator (URL) on the network.

19. The data collection system of claim 16, wherein the network includes the Internet.

20. A system for researching pestware, the system comprising:
means for detecting automatically the presence of an electronic messaging client on a computer, the electronic messaging client having an associated contact list, each contact in the contact list having an associated address on a network;
means for adding automatically a pestware research contact to the contact list, the address associated with the pestware research contact pointing to a data collection system on the network; and
means for tracing to its source on the network a pestware threat received at the data collection system via the pestware research contact.

21. The system of claim 20, wherein the electronic messaging client is one of an electronic mail (e-mail) client and an instant messaging (IM) client.

22. The system of claim 20, further comprising:
means for obtaining from the source of the pestware threat a payload associated with the pestware threat; and
means for deriving from the payload at least one characteristic for use in detecting the payload on a computer.

23. The system of claim 20, wherein the network includes the Internet.

24. A data collection system for gathering information used in detecting pestware, the system comprising:
means for receiving over a network an electronic message associated with a pestware threat, the electronic message having been addressed to a pestware research contact, the pestware research contact having been added automatically to a contact list associated with an electronic messaging client on a remote computer connected with the network, the pestware research contact having an associated network address that points to the data collection system;
means for tracing the pestware threat to its source on the network using information derived from the received electronic message;
means for obtaining from the source of the pestware threat a payload associated with the pestware threat; and
means for deriving from the payload at least one characteristic for use in detecting the payload on an affected computer.

25. The data collection system of claim 24, wherein the electronic messaging client is one of an electronic mail (e-mail) client and an instant messaging (IM) client and the electronic message is one of an e-mail message and an instant message.

26. The data collection system of claim 24, wherein the network includes the Internet.
